(19) United States
(12) Patent Application Publication
(10) Pub. No.: US 2025/0226633 A1
(43) Pub. Date: Jul. 10, 2025

(54) SYSTEM AND METHOD FOR COMPRESSING LIGHT PULSES

(71) Applicant: AMPLITUDE, PESSAC (FR)

(72) Inventor: Antoine COURJAUD, LEOGNAN (FR)

(21) Appl. No.: 18/879,216

(22) PCT Filed: Jun. 27, 2023
(86) PCT No.: PCT/EP2023/067504

§ 371 Date: Dec. 26, 2024

(30) Foreign Application Priority Data
Jun. 27, 2022 (FR) FR2206406

(51) Int. Cl. H01S 3/00; H01S 3/23

(52) U.S. Cl. CPC H01S 3/0057; H01S 3/0092; H01S 3/2308

(57) ABSTRACT

The invention relates to a system (5) for compressing light pulses emitted by a light source (2), comprising a dispersive optical system (10) configured to receive an incident light pulse (100) having a right incident wavefront of positive spectral dispersion, said dispersive optical system (10) being designed to deliver to an object point (A) a temporally compressed light pulse (110) having an inclined wavefront, said dispersive optical system (10) being designed to angularly disperse a propagation direction of the incident light pulse via at most four diffractions depending on the spectral dispersion of the incident light pulse (100), so as to form, at the object point (A), the angularly dispersed and temporally compressed light pulse (110) having an inclined wavefront.

### TECHNICAL FIELD

The present invention generally relates to the field of laser systems and in particular to the light pulse amplification compression systems.

More particularly, it relates to a system for compressing light pulses emitted by a light source.

### PRIOR ART

The “Chirped Pulse Amplification” (CPA) is a technique that is regularly used in laser systems involving ultra-short laser pulses. In such systems, a light pulse is temporally stretched before amplification in order to cause a lengthening of the light pulse duration. The stretched pulsed is then amplified in an optical amplifier device. At the exit of the optical amplifier device, a compressor compresses the amplified pulse in order to obtain a light pulse having the same pulse duration as the initial duration.

A temporally stretched light pulse can be very schematically represented by a series of wavefronts that are temporally shifted (or longitudinally shifted, according to the commonly used convention). In other words, the wavefronts lag behind each other. Such schematic representation is used here solely for the purposes of explanation and illustration on the appended figures. However, as known, the spectrum of a light pulse being generally continuous, a stretched light pulse generally has a wavefront continuum.

The compression of a light pulse can also be schematically represented by a spatial and temporal superposition (also called spatial and temporal overlap) of the wavefronts associated with the spectrum of the light pulse.

A compressed light pulse can be used in light-matter interaction applications, for example by interaction with a non-linear optical crystal under specific conditions, including spectral acceptance, phase tuning, beam quality and focusing quality. Moreover, it is desirable that the excitation wave (or pump wave) and the generated signal wave spatially (or transversely) or temporally (or longitudinally) superimpose to each other as they propagate through the interaction area. However, the light-matter interaction process is limited by a deterioration (or “walk off”) of the spatial and temporal overlap between the excitation light beam wave and another wave, for example of the signal generated as the light beam propagates in the matter.

Moreover, the propagation of a temporally compressed light pulse of ultra-short duration and/or high peak power in different media (solid, liquid or gaseous) between the compressor and the desired interaction area is associated with numerous undesirable or damaging effects of the final application targeted by the use of such light pulses. This light pulse propagation at the exit of the compressor generally induces a deterioration in the quality of the light beam, hence of the quality of temporal and spatial focusing in the desired interaction area.

In order to compensate for the degradation of the light beam between the compressor and the interaction area, it may be necessary to enlarge the beam size to reduce the energy density up to the point of use. This requires the use of large optical components at exit of the compressor. Another solution consists in propagating the temporally compressed light pulses in a vacuum, which complicates the system.

In another application for generating a Terahertz (THz) pulse radiation by interaction between an ultra-short light pulse and a non-linear material, the document “Velocity matching by pulse front tilting for large-area THz-pulse generation” by János Hebling, Gábor Almási, Ida Z. Kozma, and Jürgen Kuhl, Opt. Express Vol. 10, nº 21, 1161-1166 (2002) proposes to introduce a wavefront tilting technique (“pulse front tilt”) so as to optimize the spatial and temporal overlap, to limit the degradation thereof and to adjust the THz radiation as a function of the tilt angle of the wavefront of the light pulse in the non-linear material.

This publication uses a wavefront tilting device comprising a diffraction grating and a device for shaping the tilted wavefront comprising an optical imaging system for adapting the size and tilt of the pulse wavefront to the desired application. Tilting the wavefront makes it possible to obtain a greater spatial and temporal superposition between the pump wave and the signal wave in the non-linear crystal and thus to exceed the spatial and temporal overlap limits in the non-linear crystal.

However, such a wavefront tilting and shaping device suffers from losses of up to 75%. Moreover, the size of the diffraction-grating tilting device and of the optical imaging system has to be adapted to the size of the propagating beam, which increases the system overall footprint.

In order to remedy the above-mentioned drawbacks of the state of the art, the present invention proposes to improve the light pulse compression systems and in particular to limit the whole losses induced by such a system while reducing the size of the optical components used and the whole system footprint.

### DISCLOSURE OF THE INVENTION

More particularly, it is proposed according to the invention, a system for compressing light pulses emitted by a light source, comprising a dispersive optical system configured to receive an incident light pulse having a straight incident wavefront of positive spectral dispersion, said dispersive optical system being designed to deliver at an object point a temporally compressed light pulse having a tilted wavefront, said dispersive optical system being designed to angularly disperse a direction of propagation of the incident light pulse via at most four diffractions depending on the spectral dispersion of the incident light pulse, so as to form, at the object point, the temporally compressed light pulse 110 with a tilted wavefront and angularly dispersed.

Therefore, advantageously, the temporally compressed light pulse obtained at the exit of the dispersive optical system has both a tilted wavefront and an angular dispersion.

Moreover, the implementation of the dispersive optical system is simpler than a conventional compressor because it involves at most four diffractions. This then allows minimizing the area in which the light pulse is compressed. Advantageously, this reduction, or even disappearance, of the area in which the pulse is compressed makes it possible to limit the light beam temporal and spatial degradations (hence, to maintain the light beam quality and hence to strongly limit the compression system losses). This offers a greater freedom in implementing the compression system, particularly in terms of sizing. This finally makes it possible to reduce the costs involved in manufacturing such a system and to improve the efficiency of the dispersive optical system.

Other non-limiting and advantageous features of the compression system according to the invention, taken individually or according to all the technically possible combinations, are the following:
the temporally compressed light pulse 110 with the tilted wavefront and angularly dispersed at the object point is angularly and temporally dispersed upstream and downstream of the object point;
the dispersive optical system comprises three diffraction gratings arranged in series on the incident light pulse path, each diffraction grating of the dispersive optical system being configured to angularly disperse the direction of propagation of the incident light pulse as a function of the spectral dispersion of the incident light pulse;
the three diffraction gratings each have a first dispersion;
the dispersive optical system comprises a single diffraction grating and an optical element configured to angularly disperse a direction of propagation of the incident light pulse via at most three successive diffractions on said diffraction grating;
said optical element comprises a retro-reflective prism or a mirror optical system;
a mirror is provided, at the object point or upstream of said object point, said mirror being positioned so as to reflect the temporally compressed light pulse with the tilted wavefront;
another diffraction grating is provided, at the object point or upstream of said object point, said other diffraction grating being positioned so as to adjust the tilt angle of the wavefront of the temporally compressed light pulse with the tilted wavefront;
said other grating has a second dispersion;
an optical imaging system is provided, configured to form an image of the temporally compressed light pulse with the tilted wavefront and angularly dispersed at an image point and to form at this image point a spatially shaped, temporally compressed light pulse having a tilted wavefront with a determined tilt; and
the optical imaging system comprises a final diffraction grating arranged at the image point in the plane of the tilted wavefront of the spatially shaped, temporally compressed light pulse having a straightened wavefront, said final diffraction grating having the first dispersion.

The invention also proposes a chirped pulse laser amplification system comprising a light pulse source and a compression system as defined hereinabove, the source comprising an optical amplifier system arranged upstream of the compression system.

The invention also relates to an optical parametric amplification system comprising an optical parametric amplifier and a compression system as described hereinabove, the optical parametric amplifier being arranged upstream of the compression system.

The invention also relates to a method for compressing light pulses emitted by a light source, comprising the following steps:
receiving an incident light pulse having a straight incident wavefront of positive spectral dispersion, and
generating, by a dispersive optical system, a temporally compressed light pulse having a tilted wavefront, said dispersive optical system being designed to angularly disperse a direction of propagation of the incident light pulse via at most four diffractions as a function of the spectral dispersion of the incident light pulse, so as to form at an object point the temporally compressed light pulse 110 with an tilted wavefront and angularly dispersed.

### BRIEF DESCRIPTION OF THE DRAWINGS

The following description in relation with the appended drawings, given by way of non-limiting examples, will allow a good understanding of what the invention consists of and of how it can be implemented.

In the appended drawings:

FIG. 1 is a schematic representation of a system for generating a compressed pulse with a tilted wavefront according to the invention,

FIG. 2 is a schematic representation of a first exemplary embodiment of a system for generating a compressed pulse with a tilted wavefront according to the invention,

FIG. 3 is a schematic representation of a second exemplary embodiment of a system for generating a compressed pulse with a tilted wavefront according to the invention,

FIG. 4 is a schematic representation of a third exemplary embodiment of a system for generating a compressed pulse with a tilted wavefront according to the invention, and

FIG. 5 is a schematic representation of an example of use of a system for generating a compressed pulse with a tilted wavefront according to the invention.

It is to be noted that, in these figures, the structural and/or functional elements common to the different alternatives can have the same references numbers.

### DETAILED DESCRIPTION

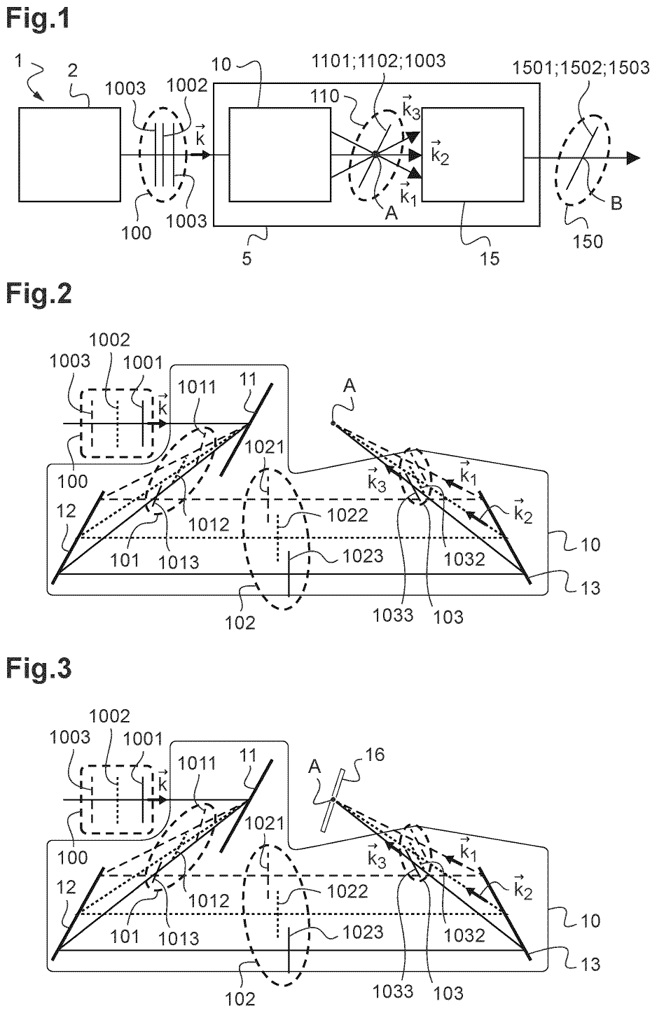

FIG. 1 is a schematic representation of a system 1 for generating a compressed pulse with a tilted wavefront according to the invention.

This system 1 for generating a compressed pulse with a tilted wavefront comprises a light source 2 and a compression system 5.

The light source 2 is designed to generate an incident light pulse 100.

In an embodiment, the light source 2 comprises for example an oscillator generating a source pulse, a stretcher and an optical amplifier system. The light source 2 generally has no compressor. As an alternative, the light source 2 can include, for example, an optical parametric amplifier (OPA) that generates a tuneable wavelength beam.

Generally, the incident light pulse 100 here has a straight incident wavefront of positive spectral dispersion. In other words, the incident light pulse 100 is temporally stretched. Hereafter, a direction of propagation is defined, denoted \vec{k}, associated with the incident light pulse 100. Here, the wavefronts 1001, 1002, 1003 of the incident light pulse 100 are temporally shifted as a function of the spectral dispersion applied. The spectral dispersion (quantified for example in square femtosecond (fs²) or in picosecond by nanometre (ps/nm)) is here determined as a function of the pulse duration. Here, this stretched pulse duration is for example between 100 picoseconds (ps) and 1 nanosecond (ns). However, the wavefronts 1001, 1002, 1003 of the incident light pulse are orthogonal to the same direction of propagation \vec{k}.

By way of non-limiting example, in FIG. 1 are shown the incident wavefronts 1001, 1002, 1003 respectively associated with three distinct spectral components of a same incident light pulse 100. However, it should be noted here that the incident wavefronts are composed of a continuum of spectral components (the discretization of the spectral components is here made for the sake of understanding the invention).

In the present document, it is understood by spectral component a light pulse, a portion of a light pulse located in a determined narrow wavelength band or narrow optical frequency band inside the spectral band, respectively of the optical frequency range associated with the light pulse.

For example, the incident light pulse 100 extends over a wavelength range of between 700 and 900 nanometres (nm).

As shown in FIG. 1, the compression system 5 comprises a dispersive optical system 10 and, as an option, an optical imaging system 15. FIGS. 2 to 4 show three exemplary embodiments of the compression system 5 according to the invention.

The dispersive optical system 10 receives as an input the incident light pulse 100 emitted by the light source 2. The dispersive optical system 10 is designed to provide as an output, at an object point A, a temporally compressed light pulse 110 having a tilted emerging wavefront. For that purpose, the dispersive optical system 10 is adapted to angularly disperse the direction of propagation of the incident light pulse 100 via at most four successive diffractions.

Therefore, at the exit of the dispersive optical system 10, the temporally compressed light pulse 110 with the tilted wavefront is formed at an object point A. Moreover, this the temporally compressed light pulse 110 with the tilted wavefront is angularly dispersed. More precisely, the temporally compressed light pulse 110 with the tilted wavefront is angularly dispersed upstream and downstream of the object point A and is superposed at the object point A.

In other words, the wavefronts 1101, 1102, 1103 respectively associated with the different spectral components of the temporally compressed light pulse 110 are spatially and temporally superimposed at the object point A. More precisely, the wavefronts 1101, 1102, 1103 are superimposed in a plane that passes by the object point A. Moreover, these wavefronts 1101, 1102, 1103, spatially and temporally superimposed at the object point A, propagate along distinct directions of propagation \vec{k}₁, \vec{k}₂, \vec{k}₃ respectively upstream and downstream of point A. Each wavefront, respectively 1001, 1102, 1103, is tilted with respect to its direction of propagation, respectively \vec{k}₁, \vec{k}₂, \vec{k}₃. In other words, at the exit of the dispersive optical system 10, the directions of propagation \vec{k}₁, \vec{k}₂, \vec{k}₃ are angularly dispersed as a function of the spectral dispersion of the incident light pulse 100.

In the present document, it is meant by “tilted wavefront” a wavefront having an angle other than 90 degrees to its direction of propagation. Preferably, a tilted wavefront has a tilt angle of between 10 and 80 degrees with respect to its direction of propagation. The tilt angle is determined as a function of the application and the wavelength of use. For example, in the case of a Terahertz pulse radiation, this tilt angle is preferably of the order of 25 degrees.

As shown in the examples illustrated in FIGS. 2 to 5, in practice, the dispersive optical system 10 here comprises three diffraction gratings: a first diffraction grating 11, a second diffraction grating 12 and a third diffraction grating 13. These three diffraction gratings 11, 12, 13 are arranged in series on the path of the incident light pulse 100, according to an arrangement defined by the distances between these gratings and the angles of incidence of the beams on each of these gratings. Each diffraction grating among the first diffraction grating 11, the second diffraction grating 12 and the third diffraction grating 13 has a first angular dispersion (identical for each of these diffractions gratings), which results in a spectral dispersion due to the differences in optical path of the different spectral components. The number of lines per millimetre determines the angular dispersion of the diffraction grating. Advantageously, the global dispersion of the dispersive optical system is of opposite sign relative to the spectral dispersion of the incident pulse.

More particularly, as schematically shown in FIGS. 2 to 5, the incident light pulse 100 is first modified by diffraction on the first diffraction grating 11 so as to form a first intermediate light pulse 101. The first diffraction grating 11 induces an angular dispersion of this first intermediate light pulse 101, more precisely an angular dispersion of the direction of propagation of the wavefronts 1011, 1012, 1013 as a function of the spectral dispersion of the incident light pulse 100 and of the dispersion of the first diffraction grating 11. Each wavefront 1011, 1012, 1013 of the first intermediate light pulse 101 propagates along a distinct direction of propagation. Given this arrangement, each wavefront 1011, 1012, 1013 of the first intermediate light pulse 101 is then tilted relative to its direction of propagation between the first diffraction grating 11 and the second diffraction grating 12.

This first intermediate light pulse 101 is then modified by diffraction on the second diffraction grating 12 so as to form a second intermediate light pulse 102. This second intermediate light pulse 102 does no longer show any angular dispersion, but has only a spatial dispersion, more precisely a spatial dispersion transverse to the direction of propagation of the wavefronts 1021, 1022, 1023 as a function of the spectral dispersion of the first intermediate light pulse 101 and of the dispersion of the second diffraction grating 12. The wavefront 1021, 1022, 1023 of the second intermediate light pulse 102 propagates along directions of propagation that are parallel to each other. By way of non-limiting example, the directions of propagation of the wavefronts 1021, 1022, 1023 are for example spatially (or transversally) spaced apart from each other, while being parallel to each other. Each wavefront 1021, 1022, 1023 is for example here orthogonal relative to its direction of propagation between the second diffraction grating 12 and the third diffraction grating 13.

This second intermediate light pulse 102 is then also modified by diffraction on the third diffraction grating 13, so as to form the tilted-wavefront, temporally compressed light pulse 110. More precisely, the third diffraction grating 13 makes it possible to form, at the object point A, the temporally compressed light pulse 110 with the tilted wavefront and angularly dispersed. For that purpose, the third diffraction grating 13 diffracts the second intermediate light pulse 102 and forms a third intermediate light pulse 103 between the third grating and the object point A. The third intermediate light pulse 103 has wavefronts 1031, 1032, 1033 that propagate along distinct direction of propagation denoted \vec{k}₁, \vec{k}₂, \vec{k}₃, respectively, which have an angular dispersion as a function of the spatial (or transverse) dispersion of the second intermediate light pulse 102 and the dispersion of the third diffraction grating 13. The directions of propagation \vec{k}₁, \vec{k}₂, \vec{k}₃ converge at the object point A to form the temporally compressed light pulse 110 with the tilted wavefront and angularly dispersed. Moreover, the respective wavefronts 1101, 1102, 1103 of the compressed light pulse 110 are spatially and temporally superimposed at the object point A, while being tilted relative to their respective directions of propagation. More precisely, the wavefronts 1101, 1102, 1103 of the compressed light pulse 110 are superimposed in a same plane that passes by the object point A. In other words, the wavefronts 1101, 1102, 1103 are in phase so as to obtain the shortest possible pulse duration. Each wavefront, respectively 1101, 1102, 1103, is tilted with respect to its direction of propagation, respectively \vec{k}₁, \vec{k}₂, \vec{k}₃. It is to be highlighted that, at the object point A, the directions of propagation \vec{k}₁, \vec{k}₂, \vec{k}₃ are angularly dispersed as a function of the transverse spatial spread and of the diffraction gratings used.

Thus, advantageously according to the invention, the temporally compressed light pulse 110 obtained at the object point A at the exit of the dispersive optical system 10 has both a tilted wavefront and an angular dispersion as a function of the spectral width of the incident light pulse and of the dispersion of the first diffraction grating 11, of the second diffraction grating 12 and of the third diffraction grating 13. In other words, at the object point A, the wavefronts of the different spectral components of the light pulse 110 are spatially and temporally superimposed to each other, which makes it possible to obtain at the object point A a temporally compressed pulse having a tilted wavefront. The position and tilt angle of the wavefront of the temporally compressed light pulse 110 are determined by the configuration and the characteristics of the diffraction gratings 11, 12, 13. However, out of the point A, i.e. upstream and downstream from the point A, the light pulse generated by the dispersive system 10 is spatially dispersed, in addition to its angular dispersion. For example, the tilt angle is between 10 and 80 degrees with respect to the direction of propagation, respectively \vec{k}₁, \vec{k}₂, \vec{k}₃.

Moreover, the implementation of the dispersive optical system 10 is better than that of a compressor of the prior art because the described arrangement makes it possible to minimize, or even to reduce to one point in space, the area in which the light pulse is compressed. In practice, this is due to the fact that the dispersive optical system is simpler to implement than a prior art compressor, because the dispersive optical system 10 requires at most four diffraction gratings, and preferably three diffraction gratings. The use of a reduced number of diffraction grating(s) enables to reduce the diffraction losses and to improve the efficiency of the dispersive optical system 10. The use of a reduced number of diffraction grating(s) also enables to reduce the costs involved in manufacturing such a system.

According to a variant of the present disclosure, the three diffraction gratings 11, 12, 13 can be replaced by three prisms or by three grisms or by a combination of three elements chosen from a diffraction grating, a prism and a grism to form at most three spectral dispersions or diffractions of the incident light pulse. In these variants, the three successive dispersive elements each have an identical angular dispersion (as explained hereinabove). They thus have a first angular dispersion identical for each of these dispersive elements.

As an alternative, the dispersive optical system 10 can comprise a single diffraction grating and an associated optical element. The optical element associated with a diffraction grating is for example a prism or a retro-prism. As an alternative, the optical element can be formed by at least one mirror. The combination of this single diffraction grating and of the optical element is also designed to angularly disperse the direction of propagation of the incident light pulse by at least three successive diffractions on the same diffraction grating (each of the three successive diffractions having an identical angular dispersion, here corresponding to the first angular dispersion as explained hereinabove. Therefore, each of the three successive diffractions makes it possible to obtain an angular dispersion that is identical for the three successive diffractions), after retro-reflection on the optical element, so as to form the compressed light pulse with a tilted emerging wavefront at an object point A, this compressed pulse having an angular dispersion of its direction of propagation that is a function of the spectral dispersion of the incident light pulse and the dispersion of the single diffraction grating.

In practice, according to this alternative, the incident light pulse is modified by diffraction by the single diffraction grating so as to form the first intermediate light pulse. The latter is then again directed towards the single diffraction grating thanks to the optical element. This first intermediate light pulse is modified again by diffraction by the single diffraction grating so as to form the second intermediate light pulse. The optical element also sends the second intermediate light pulse back to the single diffraction grating so that it is also modified by diffraction, in order to form the tilted-wavefront, temporally compressed light pulse 110.

As an alternative, the dispersive optical system can be formed by two diffraction gratings and the previously introduced optical element in such a way as to form the tilted-wavefront, compressed light pulse, via at most four successive diffractions.

At the exit of the dispersive optical system 10, the angularly dispersion obtained causes the spatial spread of the compressed light pulse 110 during the propagation of the latter after the object point A.

Advantageously, the use of a reduced number of optical components makes it possible to minimize, or even to reduce to a point in space, the area in which the light pulse is compressed, and hence to reduce the losses induced by the optical components. This thus makes it possible to improve the compactness of the system 1 for compression and spatial shaping.

As shown in FIGS. 3 to 5, the compression system 5 comprises for example a mirror 16. This mirror 16 is designed to reflect the temporally compressed light pulse 110.

In practice, the mirror 16 is positioned at the object point A where the temporally compressed light pulse 110 with the tilted wavefront and angularly dispersed is formed. As an alternative, the mirror 16 can be positioned upstream or downstream of the object point A. The mirror 16 deflects the directions of propagation \vec{k}₁, \vec{k}₂, \vec{k}₃ of the compressed pulse 110. For ease of implementation of the compression system 5, the mirror 16 is flat. However, the deflecting mirror 16 is optional.

Advantageously, according to this embodiment, the angular dispersion of the light pulse 110 locally compressed at point A enables to limit, for the following of the light pulse propagation, the spatial and temporal dispersions of the light pulse liable to be induced by non-linear optical effects in the propagation medium. Out of the point A, the transverse spatial dispersion or the angular dispersion of the light pulse make it possible to limit the non-linear optical effects and degradations due to the propagation in the ambient environment or on the optical components. In particular, the intensity of the light beam is reduced at any point of space in order to limit, or avoid, the non-linear optical effects.

Indeed, in the presence of a transverse spatial dispersion or an angular dispersion of the wavefronts, these cannot be superimposed. At the exit of the mirror 16 is then obtained by a reflected light pulse 160 that is angularly dispersed by reflection of the directions of propagation \vec{k}₁, \vec{k}₂, \vec{k}₃ on the mirror 16. The reflected light pulse 160 is hence angularly dispersed. In other words, the wavefronts 1601, 1602, 1603 of the different spectral components of the reflected light pulse 160 propagate along directions of propagation corresponding respectively to the reflection of the directions of propagation \vec{k}₁, \vec{k}₂, \vec{k}₃ on the mirror 16.

As an alternative, the mirror 16 can be replaced by a fourth diffraction grating (not shown). This fourth diffraction grating makes it possible to adjust the tilt angle of the wavefront or even to straightening the wavefront (that is thus no longer tilted). This fourth diffraction grating has a different dispersion from that of the previously introduced first diffraction grating 11, of the second diffraction grating 12 and of the third diffraction grating 13.

The fourth diffraction grating is positioned upstream of or at the object point A where the, the temporally compressed light pulse 110 with the tilted wavefront is formed. As an alternative, it can be positioned upstream of the object point A.

This fourth diffraction grating deflects the directions of propagation \vec{k}₁, \vec{k}₂, \vec{k}₃ of the spectral components of the compressed pulse 110. In practice, the characteristics of the fourth diffraction grating (in particular, the number of lines per millimetre) are adapted to the targeted application at the exit of the compression system 5.

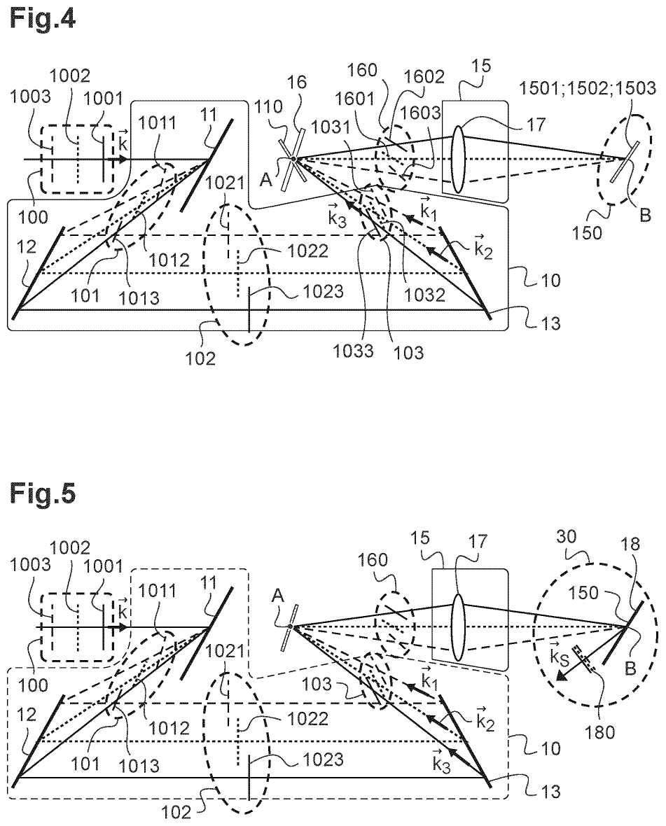

As shown in FIGS. 4 and 5, the compression system 5 optionally comprises the optical imaging system 15 positioned at the exit of the dispersive optical system 10. The optical imaging system 15 forms the image of the compressed light pulse 110 and makes it possible to adjust the tilt angle of the wavefront to obtain the desired spatial and temporal overlap at an image point B remote from the object point A. In other words, the optical imaging system 15 makes it possible to spatially shape the temporally compressed light pulse 110 with the tilted wavefront as a function of the targeted application.

The imaging system can for example be a magnification system, whose magnification influences the tilt angle of the wavefront.

The reflected light pulse 160 then propagates downstream of the mirror 16 (or, as an alternative, the fourth diffraction grating) towards the optical imaging system 15. More precisely, the reflected light pulse 160 propagates up to an optical system 17 comprised in the optical imaging system 15 (FIGS. 4 and 5). This optical system 17 is designed to shape the reflected light pulse 160 so that the latter can be exploited for the targeted applications at the exit of the compression system 5.

The optical system 17 comprises for example an optical system based on lens(es) or mirror(s). The optical components comprised in the optical system 17 are, for example, spherical optical components to focus at a point or cylindrical optical components to focus on a line. The cylindrical optical components are particularly advantageous because they allow implementation in the open air (whereas the spherical optical components require working in a vacuum atmosphere).

The optical system 17 comprises for example two optical components, each optical component being positioned in a different plane, the two planes being orthogonal to each other.

More precisely, the optical magnification of the optical system 17 enables to adjust the tilt angle of the wavefront at the image point B. In other words, the optical system 17 moves the temporally compressed pulse from the object point A to the image point B and rotates the plane of the tilted wavefront of the temporally compressed pulse to arrange and superimpose it where required for the application. Between the object point A and the image point B, the light pulse remains spatially dispersed, which allows avoiding the generation of undesirable effects during the propagation of the light pulse between these two points.

Advantageously, the mirror 16 (or, as an alternative, the fourth diffraction grating) and the optical system 17 of the optical imaging system 15 enable to spatially and temporally superimpose the components of the reflected light pulse 160 at an image point B. In particular, at the image point B, the shaped light pulse 150 is compressed, spatially and temporally recombined and has a tilted emerging wavefront. More precisely, the wavefronts 1501, 1502, 1503 overlap in a plane that passes by the image point B. In the absence of another optical component (in particular, a diffraction grating 18, as described hereinafter), out of the image point B, these wavefronts 1501, 1502, 1503 propagate along distinct directions of propagation as a function of the directions of propagation \vec{k}₁, \vec{k}₂, \vec{k}₃, respectively, at the entry of the optical imaging system 15. Each wavefront, respectively 1501, 1502, 1503, is tilted with respect to its direction of propagation. In other words, at the exit of the optical imaging system 15, the shaped and temporally compressed light pulse 150 has also a tilted wavefront and an angular dispersion of its direction of propagation as a function of the spectral dispersion of the incident light pulse.

The shaped and compressed light pulse 150, with a tilted wavefront, can be used for the targeted application at the image point B. In other words, the shaped and compressed light pulse 150, with a tilted wavefront, can be used at the image point B remote from the object point A, without generating undesirable non-linear optical effects between the object point A and the image point B.

FIG. 5 shows a second example of a compression system 5 according to the invention. In this example, the optical imaging system further comprises a final diffraction grating 18. This final diffraction grating 18 is positioned in the optical imaging system 15 at the exit of the optical system 17. This final diffraction grating 18 has the same dispersion as that of the previously introduced first diffraction grating 11, second diffraction grating 12 and third diffraction grating 13. The final diffraction grating 18 thus receives a shaping light pulse 150 obtained at the exit of the other optical element 17.

More precisely, the final diffraction grating 18 is positioned at the above-described image point B, i.e. at the place where the shaped light pulse 150 is compressed, spatially and temporally recombined and has a tilted emerging wavefront. Advantageously, the final diffraction grating 18 is flat. The final diffraction grating 18 is tilted so that the plane of the final diffraction grating coincides with the plane of the tilted wavefront of the shaped and compressed light pulse 150.

This final diffraction grating 18 enables to straighten the different spectral components of the shaped light pulse 150 so that they propagate along a same direction of propagation \vec{k}ₛ. Therefore, the wavefronts 1501, 1502, 1503 spatially and temporally superimposed at the image point B, propagate along the same direction of propagation \vec{k}ₛ at the exit of the final diffraction grating 18. Each wavefront, respectively 1501, 1502, 1503, is tilted by a same non-zero angle with respect to the direction of propagation \vec{k}ₛ. In other words, at the exit of the optical imaging system 15, the direction of propagation \vec{k}ₛ of the shaped and temporally compressed light pulse 180 has no angular dispersion. Moreover, the pulse wavefront 180 is straightened.

The shaped and compressed light pulse 180 with the tilted wavefront can be used from the image point B along the direction of propagation \vec{k}ₛ at any point.

In the case of an application with an experience carried out in a vacuum or in a particular medium, e.g. gas, advantageously, only the final diffraction grating 18 is arranged inside the experiment chamber 30 in a vacuum or filled with a gaseous medium. However, the compression system 10 and the other optical components of the optical imaging system 15 can be arranged outside the chamber 30. Indeed, the angular dispersion of the compressed pulse before the image point B limits the risks to generate undesirable non-linear optical effects (in the air, for example). Moreover, this configuration makes it possible to reduce the size of the equipment, in particular of the vacuum chamber 30, and hence to reduce the associated costs. Moreover, the integrity of the compressed light pulse 180 with the tilted wavefront is improved because the optical path of the image B and the desired interaction area is shorter than in a compression system of the prior art.

Advantageously, the compression and spatial shaping system according to the invention can be integrated in a chirped pulse amplifier, instead of a conventional compressor, in order to generate ultra-short, amplified light pulses, in particular femtosecond pulses, i.e. with duration of between 5 femtoseconds and 10 picoseconds. The compression system of the present disclosure finds in particular applications in a titanium-sapphire laser, a rare-earth-doped glass-matrix laser, e.g. a ytterbium-YAG laser (Yb:YAG), a neodymium-YAG laser (Nd:YAG), a thulium-YAG laser (Tm-YAG) or an erbium-YAG laser (Er-YAG) or a neodymium-doped yttrium lithium fluoride laser (Nd:YLF), or in a fibre laser.

The compression and spatial shaping system according to the invention can also be combined to an optical parametric amplifier for generating a radiation of variable wavelength by sum frequency generation (or SFG). Indeed, in this case, the angular dispersion of the beams makes it easier to separate the different harmonics generated.

The compression and spatial shaping system also finds applications for the generation of Terahertz radiation by interaction between a tilted-wavefront temporally compressed pulse and a non-linear optical component.

The compression and spatial shaping system finds advantageous applications for inverse Compton scattering (or Thomson scattering), where the beams intersect at a high angle of incidence, so that the tilt of the wavefront enables better superposition with a packet of electrons.

The compression and spatial shaping system also finds other applications for dielectric laser acceleration (or DLA).

The compression and spatial shaping system 1 described hereinabove enables to implement the following method for compression and spatial shaping of tilted-wavefront light pulses.

In accordance with the method according to the invention, the light source 2 generates an incident light pulse 100. This incident light pulse 100 has a straight incident wavefront of positive spectral dispersion.

This incident light pulse 100 propagates towards the compression system 5, and more particularly towards the dispersive optical system 10 of the compression system 5 along a direction of propagation, denoted \vec{k}. Generally, the incident wavefront associated with each spectral component of the incident light pulse are orthogonal to the direction of propagation \vec{k}. In other words, the incident wavefronts 1001, 1002, 1003 are orthogonal to the direction of propagation \vec{k}.

Optionally, the method continues with a step in which the dispersive optical system 10 receives the incident light pulse 100. The dispersive optical system 10 then provides as an output, via at most four successive diffractions of the incident light pulse 100, the temporally compressed light pulse 110 having a tilted wavefront at an object point A. At the exit of the dispersive optical system 10, the compressed light pulse 110 with the tilted wavefront is formed at the object point A. In other words, the wavefronts 1101, 1102, 1103 associated with the compressed light pulse 110 are spatially and temporally superimposed at the object point A. More precisely, the wavefronts 1101, 1102, 1103 overlap spatially and temporally in a plane that passes through the object point A. Moreover, these wavefronts 1101, 1102, 1103 overlapped spatially and temporally at the object point A, propagate along distinct directions of propagation \vec{k}₁, \vec{k}₂, \vec{k}₃, respectively. Each wavefront, respectively 1101, 1102, 1103, is tilted with respect to its direction of propagation, respectively \vec{k}₁, \vec{k}₂, \vec{k}₃. Therefore, this compressed light pulse 110 with the tilted wavefront is angularly dispersed.

The method then continues with a step during which the compressed light pulse 110 is spatially shaped by the optical imaging system 15 in order to form an image of the compressed light pulse 110 with the tilted wavefront at an image point B according to a desired tilt angle. At the exit of the optical imaging system 15, the light pulse obtained is the spatially shaped and temporally compressed light pulse 150, having a tilted wavefront at the image point B, which is the image of the object point A. The optical imaging system makes it possible to position the wavefront of the shaped and temporally compressed light pulse 150 so as to superimpose it at the desired image point B according to the application. The tilt angle of the wavefront at the image point B depends in particular of the orientation of the deflecting mirror 16 and/or of the optical magnification of the optical system 17.

Optionally, the method further includes an additional step consisting in diffracting the shaped and compressed light pulse 150 at the image point B on a diffraction grating arranged in the plane of the tilted wavefront of the shaped and compressed light pulse 150, so as to superimpose the spectral components of the shaped and compressed light pulse 150 along a same direction of propagation \vec{k}ₛ.

1. A system (5) for compressing light pulses emitted by a light source (2), comprising a dispersive optical system (10) adapted to receive an incident light pulse (100) having a straight incident wavefront of positive spectral dispersion, said dispersive optical system (10) being designed to deliver at an object point (A) a temporally compressed light pulse (110) having a tilted wavefront, said dispersive optical system (10) being designed to angularly disperse a direction of propagation of the incident light pulse via at most four diffractions depending on the spectral dispersion of the incident light pulse (100), so as to form, at the object point (A), the temporally compressed light pulse (110) with a tilted wavefront and angularly dispersed.

2. The compression system (5) according to claim 1, wherein the dispersive optical system (10) comprises three diffraction gratings (11, 12, 13) arranged in series on the incident light pulse path (100), each diffraction grating (11, 12, 13) of the dispersive optical system (10) being configured to angularly disperse the direction of propagation of the incident light pulse (100) as a function of the spectral dispersion of the incident light pulse (100).

3. The compression system according to claim 2, wherein the three diffraction gratings (11, 12, 13) each have a first dispersion.

4. The compression system (5) according to claim 1, wherein the dispersive optical system (10) comprises a single diffraction grating and an optical element configured to angularly disperse a direction of propagation of the incident light pulse via at most three successive diffractions on said diffraction grating.

5. The compression system (5) according to claim 4, wherein said optical element comprises a retro-reflective prism or a mirror optical system.

6. The compression system (5) according to claim 1, comprising a mirror (16) arranged at the object point (A) or upstream of said object point (A), said mirror (16) being positioned so as to reflect the temporally compressed light pulse (110) with the tilted wavefront.

7. The compression system (5) according to claim 1, comprising another diffraction grating arranged at the object point (A) or upstream of said object point (A), said other diffraction grating being positioned so as to adjust the tilt angle of the wavefront of the temporally compressed light pulse (110) with the tilted wavefront.

8. The compression system (5) according to claim 7, wherein said other grating has a second dispersion.

9. The compression system (5) according to claim 1, comprising an optical imaging system (15) configured to form an image of the temporally compressed light pulse (110) with the tilted wavefront and angularly dispersed at at an image point (B) and to form at this image point (B) a spatially shaped, temporally compressed light pulse (150) with an tilted wavefront according to a determined tilt angle.

10. The compression system (5) according to claim 9, in dependence of claim 3, wherein the optical imaging system (15) comprises a final diffraction grating (18) arranged at the image point (B) in the plane of the tilted wavefront of the spatially shaped, temporally compressed light pulse (150) with a straightened wavefront, said final diffraction grating (18) having the first dispersion.

11. A chirped pulse laser amplification system comprising a light pulse source (2) and a compression system (5) according to claim 1, the source (2) comprising an optical amplifier system arranged upstream of the compression system (5).

12. An optical parametric amplification system comprising an optical parametric amplifier and a compression system (5) according to claim 1, the optical parametric amplifier being arranged upstream of the compression system (5).

13. A method for compressing light pulses emitted by a light source (2), comprising the following steps:
receiving an incident light pulse (100) having a straight incident wavefront of positive spectral dispersion, and
generating, by a dispersive optical system (10), a temporally compressed light pulse (110) having a tilted wavefront, said dispersive optical system (10) being designed to angularly disperse a direction of propagation of the incident light pulse (100) via at most four diffractions as a function of the spectral dispersion of the incident light pulse (100), so as to form at an object point (A) the temporally compressed light pulse (110) with an tilted wavefront and angularly dispersed.
